(19) United States
(12) Patent Application Publication
(10) Pub. No.: US 2026/0081086 A1
(43) Pub. Date: Mar. 19, 2026

(54) PRESSING DEVICE

(71) Applicant: Chicony Electronics Co., Ltd., New Taipei City (TW)

(72) Inventors: Cheng-Chi Hsu, New Taipei City (TW); Yen-Ching Lee, New Taipei City (TW); Shih Hao Lu, New Taipei City (TW)

(73) Assignee: Chicony Electronics Co., Ltd., New Taipei City (TW)

(21) Appl. No.: 19/251,845

(22) Filed: Jun. 27, 2025

(30) Foreign Application Priority Data
Sep. 16, 2024 (TW) 113210056

(51) Int. Cl. H01H 27/10; H01H 13/02; H01H 13/14; H01H 36/00

(52) U.S. Cl. CPC H01H 27/10; H01H 13/023; H01H 13/14; H01H 36/008; H01H 2215/00; H01H 2235/01; H01H 2239/022

(57) ABSTRACT

A pressing device includes a circuit board, a shaft lower cover, a shaft upper cover, and a movable shaft body. The circuit board includes first and second surfaces, a through hole penetrating the surfaces, and an induction coil surrounding the hole. The shaft lower cover includes a lower cover base disposed on the first surface. The shaft upper cover on the lower base includes an opening. The movable shaft body is movably disposed between the shaft upper and lower covers, and includes a movable base partially protruding from an opening and a columnar shaft is connected to an induction member. When the movable shaft body is pressed down, the columnar shaft extends into the hollow shaft base, and the induction member passes through the through hole, causing the induction coil to produce changes of induced current.

### CROSS-REFERENCE TO RELATED APPLICATION

This application claims the priority benefit of Taiwan application serial no. 113210056, filed on Sep. 16, 2024. The entirety of the above-mentioned patent application is hereby incorporated by reference herein and made a part of this specification.

### BACKGROUND

### Technical Field

The disclosure relates to a pressing device, and particularly relates to a pressing device with an induction coil.

### Description of Related Art

Currently, a common pressing device is triggered by pressing a button and causing the switch below to be turned on. With the advancement of technology, how to make pressing devices provide multiple triggering methods is a research direction in this field.

### SUMMARY

The disclosure provides a pressing device, which has an induction coil and is triggered by changes of induced current.

A pressing device provided by the disclosure includes a circuit board, a shaft lower cover, a shaft upper cover, and a movable shaft body. The circuit board includes a first surface and a second surface opposite to each other, a through hole penetrating the first surface and the second surface, and an induction coil surrounding the through hole. The shaft lower cover includes a lower cover base and a hollow shaft base protruding from the lower cover base, in which the lower cover base is disposed on the first surface. The shaft upper cover is disposed on the lower cover base and includes an opening. The movable shaft body is movably disposed between the shaft upper cover and the shaft lower cover, and includes a movable base and a columnar shaft protruding from the movable base, in which the movable base partially protrudes from the opening, and the columnar shaft is connected to an induction member. When the movable shaft body is pressed down, the columnar shaft extends into the hollow shaft base, and the induction member passes through the through hole, causing the induction coil to produce changes of induced current.

In an embodiment of the disclosure, the pressing device further includes a light emitter and a light receiver, in which the hollow shaft base includes two flap portions separated from each other, a light path is formed between the two flap portions, the light emitter and light receiver are disposed on the second surface and are positioned on two sides of the two flap portions. When the movable shaft body is not pressed down, light emitted by the light emitter is received by the light receiver via the light path.

In an embodiment of the disclosure, when the movable shaft body is pressed down, the induction member is located in the light path, and the light emitted by the light emitter is blocked by the induction member.

In an embodiment of the disclosure, the columnar shaft of the movable shaft body is opaque. When the movable shaft body is pressed down, the columnar shaft is located in the light path, and the light emitted by the light emitter is blocked by the columnar shaft.

In an embodiment of the disclosure, the pressing device further includes a magnetic sensor disposed on the circuit board and positioned near the hollow shaft base. The induction member is a magnet. When the movable shaft body is pressed down, the magnet passes through the through hole, and moves close to or away from the magnetic sensor.

In an embodiment of the disclosure, the magnetic sensor is disposed on the first surface.

In an embodiment of the disclosure, the magnetic sensor is disposed on the second surface.

In an embodiment of the disclosure, the magnet is a rectangular body.

In an embodiment of the disclosure, the pressing device further includes an elastic element positioned between the shaft lower cover and the shaft upper cover, and fitted around the columnar shaft for the pressed movable shaft body to return to the original position.

In an embodiment of the disclosure, the pressing device further includes a metal spring plate disposed between the shaft lower cover and the shaft upper cover to provide tactile feedback during pressing.

In an embodiment of the disclosure, the pressing device further includes a buffer member. The movable shaft body includes a positioning portion protruding from the side of the movable base. The buffer member is fitted around a positioning portion of the movable shaft body. The positioning portion is positioned between the shaft lower cover and the shaft upper cover.

In an embodiment of the disclosure, when the movable shaft body is not pressed down, the buffer member abuts the shaft upper cover. When the movable shaft body is pressed down, the buffer member abuts the shaft lower cover.

In an embodiment of the disclosure, the opening is a rectangle, and the outer contour of the movable base corresponds to the inner contour of the opening.

In an embodiment of the disclosure, the shaft lower cover includes a first engaging portion, and the shaft upper cover includes a second engaging portion corresponding to the first engaging portion.

Based on the above, the circuit board of the pressing device provided by the disclosure includes the induction coil surrounding the through hole. The lower cover base of the shaft lower cover is installed on the first surface of the circuit board, and the hollow shaft base penetrates the through hole and protrudes from the second surface of the circuit board. The shaft upper cover is disposed on the lower cover base. The movable shaft body is movably disposed between the shaft upper cover and the shaft lower cover, and includes a movable base and a columnar shaft protruding from the movable base. The movable base partially protrudes from the opening of the shaft upper cover, and the columnar shaft is embedded with the induction member. When the movable shaft body is pressed down, the columnar shaft extends into the hollow shaft base, and the induction member passes through the through hole, causing the induction coil to produce changes of induced current, providing a triggering method that is different from the conventional method. In addition, the through hole of the circuit board is designed for the hollow shaft base to penetrate, so that part of the height of the hollow shaft base overlaps with the thickness of the circuit board, which can reduce the overall height of the pressing device and make the pressing device suitable for thin models.

### BRIEF DESCRIPTION OF THE DRAWINGS

FIG. 1 is a schematic view of the appearance of a pressing device according to an embodiment of the disclosure.

FIG. 2 is an exploded view of FIG. 1.

FIG. 3 is a cross-sectional view along a line A-A in FIG. 1.

FIG. 4 is a schematic view of a movable shaft body in FIG. 3 being pressed down.

FIG. 5 is a cross-sectional view of a pressing device according to another embodiment of the disclosure.

FIG. 6 is a schematic view of the movable shaft body in FIG. 5 being pressed down.

FIG. 7 is a schematic view of the appearance of the bottom surface of the pressing device in FIG. 5.

FIG. 8 is a cross-sectional view of a pressing device according to another embodiment of the disclosure.

FIG. 9 is a schematic view of the movable shaft body in FIG. 8 being pressed down.

FIG. 10 is a cross-sectional view of a pressing device according to another embodiment of the disclosure.

FIG. 11 is a cross-sectional view of a pressing device according to another embodiment of the disclosure.

FIG. 12 is another cross-sectional view of the pressing device in FIG. 11.

### DESCRIPTION OF THE EMBODIMENTS

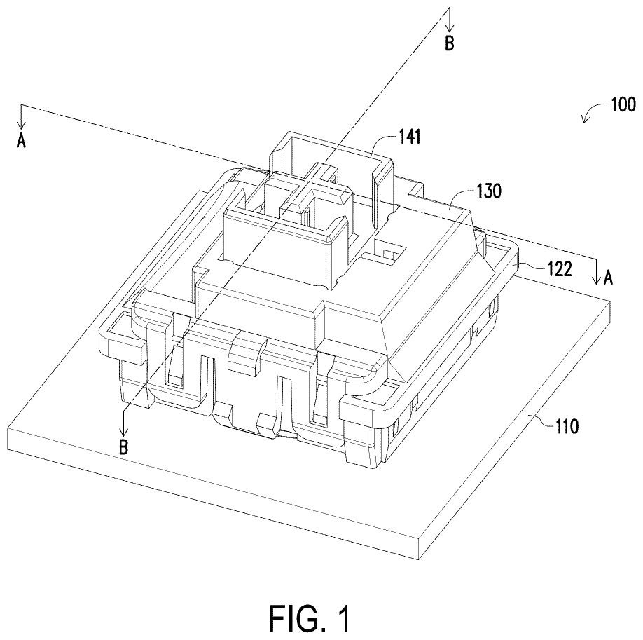

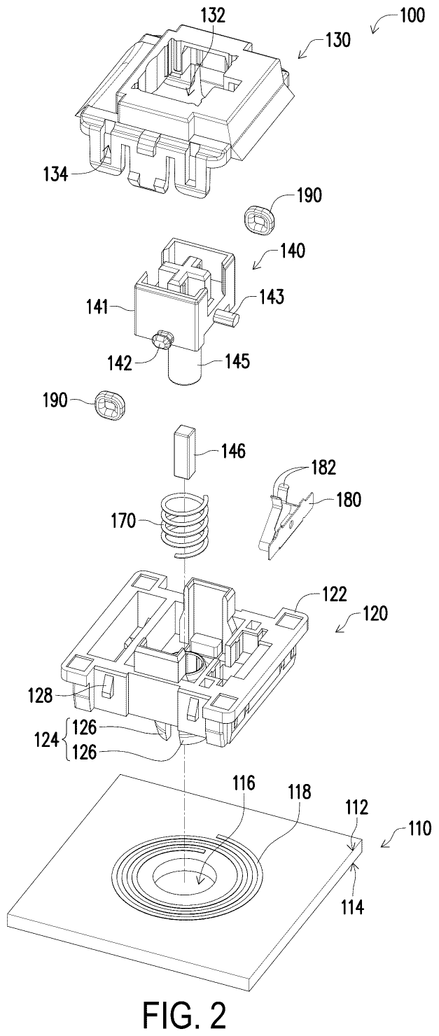

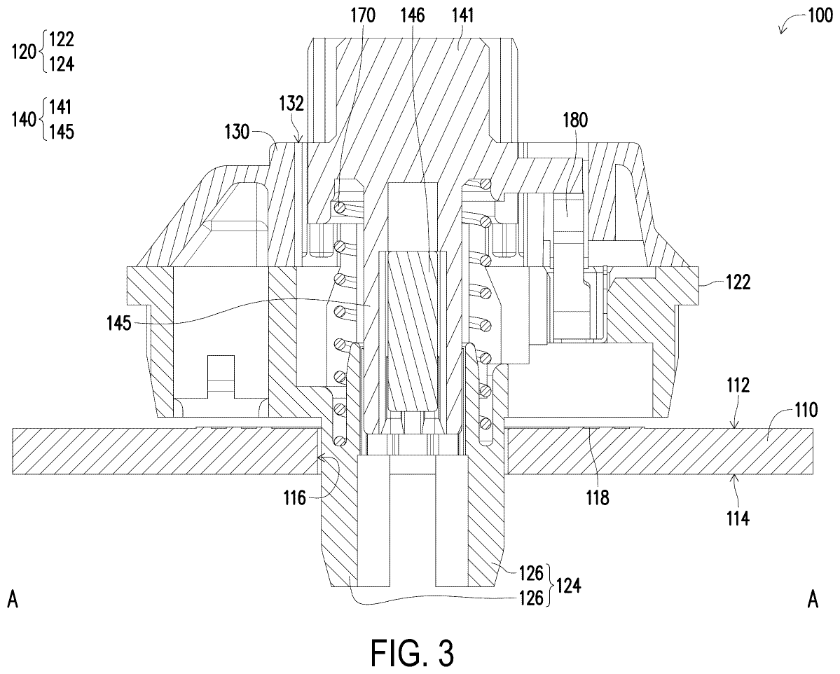

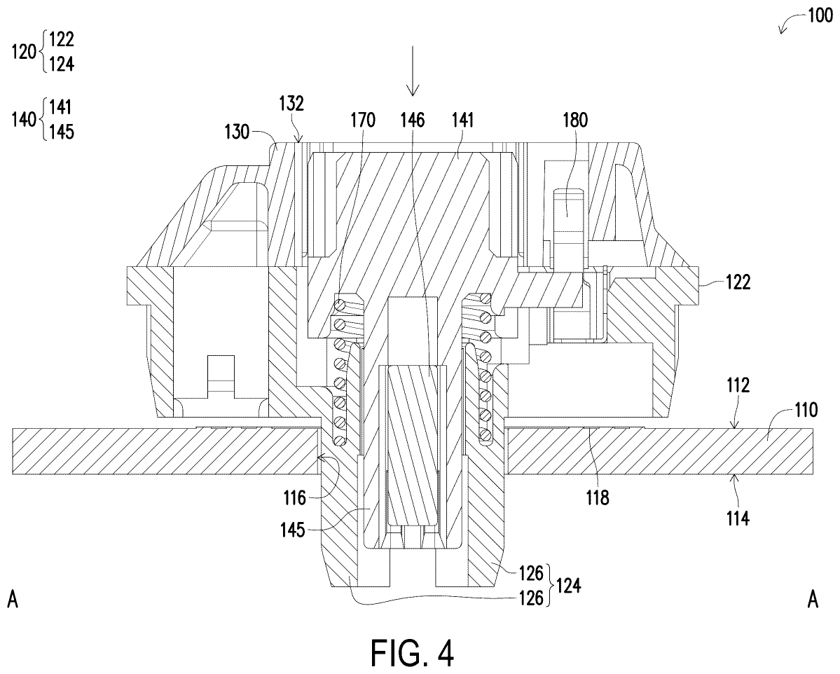

FIG. 1 is a schematic view of the appearance of a pressing device according to an embodiment of the disclosure. FIG. 2 is an exploded view of FIG. 1. FIG. 3 is a cross-sectional view along a line A-A in FIG. 1. FIG. 4 is a schematic view of a movable shaft body in FIG. 3 being pressed down.

Referring to FIG. 1 to FIG. 4, a pressing device 100 in this embodiment is, for example, the part hidden beneath the keycap in a keyboard key, but the type of the pressing device 100 is not limited thereto. As shown in FIG. 2, the pressing device 100 includes a circuit board 110, a shaft lower cover 120, a shaft upper cover 130, and a movable shaft body 140.

The circuit board 110 includes a first surface 112 and a second surface 114 opposite to each other, a through hole 116 penetrating the first surface 112 and the second surface 114, and an induction coil 118 surrounding the through hole 116. The induction coil 118 may be disposed on the first surface 112, or may be disposed on the second surface 114. In an embodiment, the induction coil 118 may be disposed on the first surface 112 and the second surface 114. In this embodiment, the induction coil 118 is disposed on the first surface 112, but the arrangement manner of the induction coil 118 is not limited thereto.

As shown in FIG. 3, the shaft lower cover 120 includes a lower cover base 122 and a hollow shaft base 124 protruding from the lower cover base 122. The lower cover base 122 is disposed on the first surface 112, and the hollow shaft base 124 penetrates the through hole 116 of the circuit board 110 and protrudes from the second surface 114.

In this embodiment, the through hole 116 of the circuit board 110 is designed for the hollow shaft base 124 to penetrate, so that a part of the height of the hollow shaft base 124 overlaps with the thickness of the circuit board 110, thereby reducing the overall height of the pressing device 100. Therefore, the pressing device 100 can be applied to thin models, but it is not limited thereto. In another embodiment, the lower cover base 122 is disposed on the first surface 112, the hollow shaft base 124 is located within the through hole 116 of the circuit board 110. That is, a height of the hollow shaft base 124 is less than or equal to a thickness of the circuit board 110.

In addition, the shaft upper cover 130 is disposed on the lower cover base 122. Specifically, as shown in FIG. 2, the shaft lower cover 120 includes a first engaging portion 128, and the shaft upper cover 130 includes a second engaging portion 134 corresponding to the first engaging portion 128. The shaft upper cover 130 is fixed to the shaft lower cover 120 through the engagement of the first engaging portion 128 and the second engaging portion 134. Certainly, the manner of the shaft upper cover 130 being fixed to the lower cover base 122 is not limited thereto.

The shaft upper cover 130 includes an opening 132. In addition, the movable shaft body 140 is movably disposed between the shaft upper cover 130 and the shaft lower cover 120. The movable shaft body 140 includes a movable base 141 and a columnar shaft 145 extending downward from the bottom of the movable base 141. The keycap (not shown) may be installed on the movable base 141 and move with the movable base 141. Therefore, when the user presses the keycap, the movable shaft body 140 moves downward accordingly.

The movable base 141 partially protrudes from the opening 132 of the shaft upper cover 130. In this embodiment, the opening 132 of the shaft upper cover 130 is a rectangle, the movable base 141 is a rectangle, and the outer contour of the movable base 141 corresponds to the inner contour of the opening 132. Therefore, the movable base 141 of the movable shaft body 140 may be limited by the edge of the opening 132 of the shaft upper cover 130, and move straight up and down, so as to reduce the left and right shaking of the movable shaft body 140 during the up and down movement, thereby achieving a stable pressing effect.

In addition, the shape of the columnar shaft 145 corresponds to the shape of the hollow shaft base 124 of the lower cover 120. The columnar shaft 145 is cylindrical, and the hollow shaft base 124 of the lower cover 120 is in the corresponding cylindrical shape. The outer contour of the columnar shaft 145 and the inner contour of the hollow shaft base 124 are matched for position limiting, so as to ensure stable movement of the columnar shaft 145 within the hollow shaft base 124, thereby reducing shaking and achieving a stable pressing effect.

In addition, the columnar shaft 145 is connected to an induction member 146. The induction member 146 is configured to pass through the through hole 116 so that the induction coil 118 generates induced current. The induction member 146 may be made of magnetic materials (e.g. permeable or diamagnetic), iron, magnet, conductive metal (such as aluminum or copper) or magnetically conductive materials such as silicon steel or composite materials, but the type of the induction member 146 is not limited thereto. In this embodiment, the columnar shaft 145 is hollow, and the induction member 146 is disposed inside the columnar shaft 145. In an embodiment, the columnar shaft 145 may not be hollow, and the induction member 146 is also disposed outside the columnar shaft 145. The induction member 146 may be directly connected to the columnar shaft 145, or the induction member 146 may be indirectly connected to the columnar shaft 145 through other component. The form of the columnar shaft 145 and the disposition position of the induction member 146 are not limited thereto.

It may be seen from FIG. 4 that when the movable shaft body 140 is pressed down, the columnar shaft 145 extends into the hollow shaft base 124, and the induction member 146 passes through the through hole 116, causing the induction coil 118 to produce changes of induced current. Therefore, the pressing device 100 may be triggered by the changes of induced current received by the induction coil 118. Specifically, as shown in FIG. 3 and FIG. 4, the induction member 146 is located above the circuit board 110, and the induction coil 118 is disposed at the first surface 112. When the movable shaft body 140 moves toward the circuit board 110, the induction member 146 approaches the induction coil 118 and passes through the through hole 116, so that the induction member 146 and the induction coil 118 are inductively coupled to generate a change in inductance. Alternatively, in one embodiment, the induction coil 118 may also be disposed at the first surface 112 and/or the second surface 114.

In another embodiment, the induction coil 118 is disposed at the second surface 114. When the movable shaft body 140 is not pressed down, a portion (bottom) of the induction member 146 is located in the through hole 116, that is, the portion is located between the first surface 112 and the second surface 114. Certainly, a position of the induction member 146 at the circuit board 110 is not limited thereto. Similarly, this configuration can also allow the induction member 146 to approach the induction coil 118 to generate an induction change and determine the degree of pressing of the movable shaft body 140.

In addition, in this embodiment, the pressing device 100 further includes an elastic element 170. The elastic element 170 is, for example, a spring, but the disclosure is not limited thereto. The elastic element 170 is positioned between the shaft lower cover 120 and the shaft upper cover 130, and is fitted around the columnar shaft 145 for the pressed movable shaft body 140 to return to the original position.

Furthermore, as shown in FIG. 2 and FIG. 3, the pressing device 100 further includes a metal spring plate 180 disposed between the shaft lower cover 120 and the shaft upper cover 130 to provide tactile feedback during pressing. In addition, as shown in FIG. 2, the side of the movable shaft body 140 has a protrusion column 143 corresponding to two clamping portions 182 of the metal spring plate 180, and when the movable shaft body 140 is pressed down, the protrusion column 143 slides between the two clamping portions 182 of the metal spring plate 180. The clamping force of the two clamping portions 182 on the protrusion column 143 is used to provide the tactile feedback during pressing.

As shown in FIG. 2, the movable shaft body 140 includes a positioning portion 142 protruding from the side of the movable base 141. The positioning portion 142 is positioned between the shaft lower cover 120 and the shaft upper cover 130. The pressing device 100 further includes a buffer member 190. The buffer member 190 is a soft object, which is annular-shaped in this embodiment, but the disclosure is not limited thereto. The buffer member 190 is fitted around the positioning portion 142 of the movable shaft body 140 to prevent a situation where the movable shaft body 140 directly collides with the shaft lower cover 120 and the shaft upper cover 130 during movement and causing noise.

The following describes the pressing device of other embodiments. The same or similar components as in the previous embodiments are represented by the same or similar reference signs, details will not be repeated, and only the main differences will be explained.

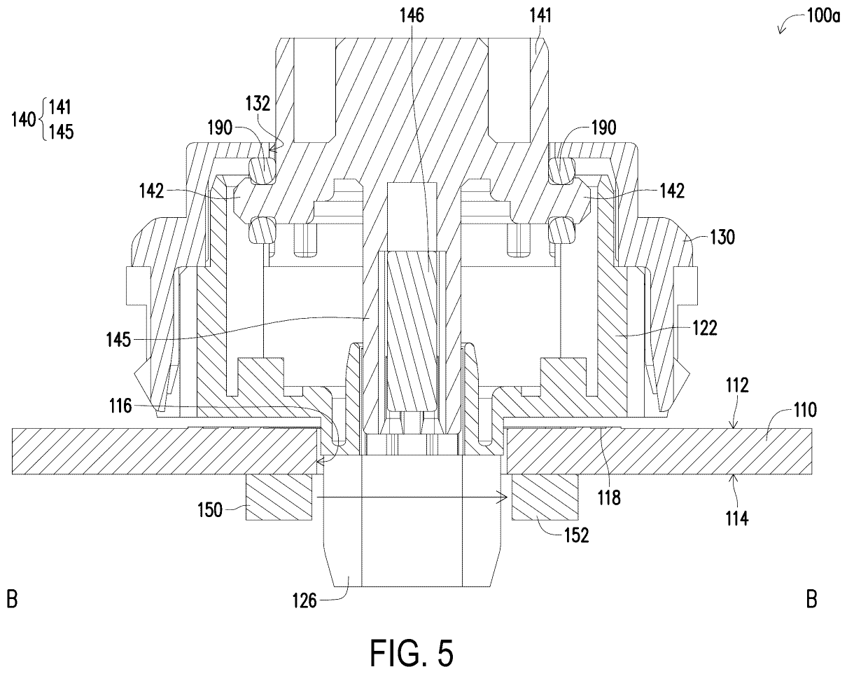

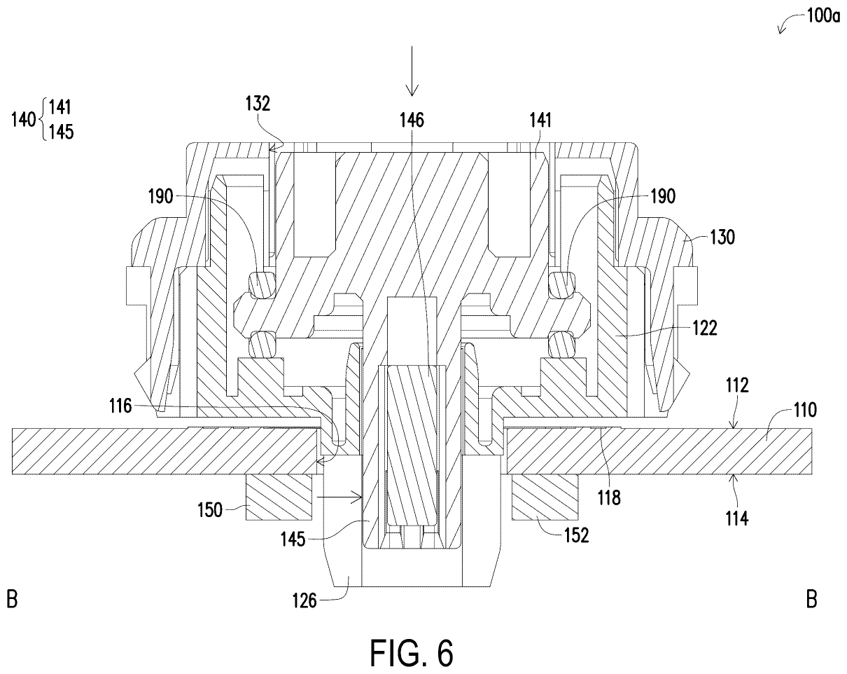

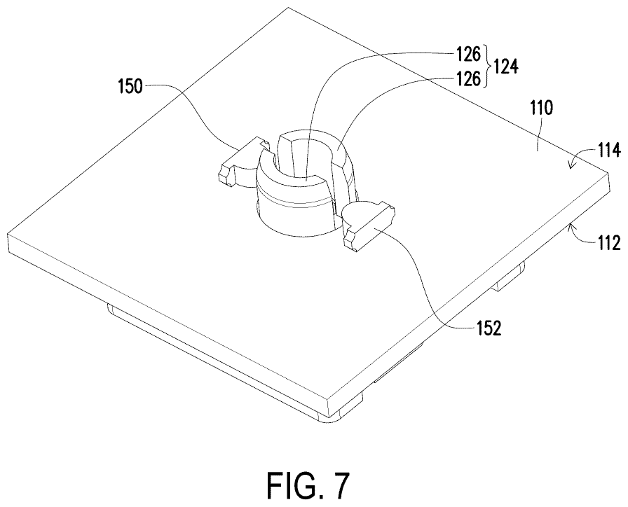

FIG. 5 is a cross-sectional view of a pressing device according to another embodiment of the disclosure. FIG. 6 is a schematic view of the movable shaft body in FIG. 5 being pressed down. FIG. 7 is a schematic view of the appearance of the bottom surface of the pressing device in FIG. 5. It should be noted that the cross-sections in FIG. 5 and FIG. 6 are similar to the cross-section taken along a line B-B in FIG. 1, and are different from the cross-section taken along the line A-A in FIG. 3 and FIG. 4.

Referring to FIG. 5 to FIG. 7, the difference between a pressing device 100a of this embodiment and the pressing device 100 in FIG. 1 is that in this embodiment, the pressing device 100a further includes a light emitter 150 and a light receiver 152. The light emitter 150 may be an LED, but the type of the light emitter 150 is not limited thereto.

As may be seen from FIG. 7, the hollow shaft base 124 includes two flap portions 126 separated from each other. A symmetrical opening is provided between the two flap portions 126 for light to pass through, and a light path is formed. The light emitter 150 and the light receiver 152 are disposed on the second surface 114 and are positioned on two sides of the two flap portions 126, especially at two ends of the light path between the two flap portions 126.

As shown in FIG. 5, when the movable shaft body 140 is not pressed down, the light emitted by the light emitter 150 is received by the light receiver 152 via the light path. As shown in FIG. 6, when the movable shaft body 140 is pressed down, the columnar shaft 145 and the induction member 146 are located in the light path. Since the columnar shaft 145 of the movable shaft body 140 is opaque, the light emitted by the light emitter 150 is blocked by the columnar shaft 145. Therefore, the light receiver 152 does not receive the light emitted from the light emitter 150. Therefore, the pressing device 100a may determine whether it is triggered by whether the light receiver 152 receives light.

Certainly, in an embodiment, the columnar shaft 145 of the movable shaft body 140 may also be light-transmissive. When the movable shaft body 140 is pressed down, the light emitted by the light emitter 150 is still blocked by the induction member 146, and similarly, the receiver does not receive the light emitted by the light emitter 150.

In this embodiment, the pressing device 100a may be triggered by the changes of induced current received by the induction coil 118, or/and may determine whether it is triggered by whether the light receiver 152 receives light. The user may choose which trigger method to use through settings, or the pressing device 100a may also enable multiple trigger methods at the same time.

In addition, it may be seen from FIG. 5 that when the movable shaft body 140 is not pressed down, the buffer member 190 abuts the shaft upper cover 130. It may be seen from FIG. 6 that when the movable shaft body 140 is pressed down, the buffer member 190 abuts the shaft lower cover 120. Therefore, the buffer member 190 can effectively prevent the movable shaft body 140 from directly colliding with the shaft lower cover 120 and the shaft upper cover 130 during movement, thereby reducing the sound generated during collision.

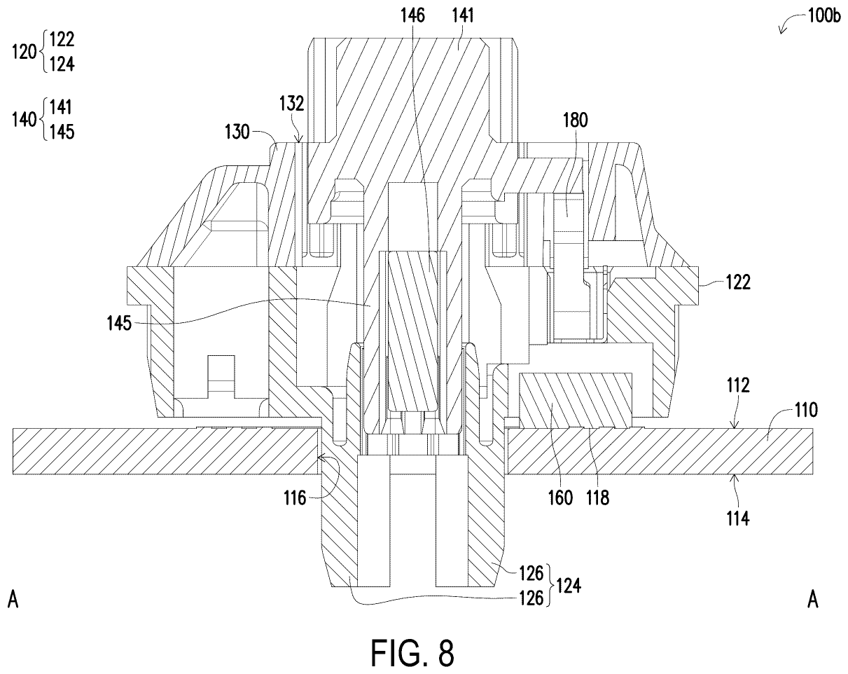

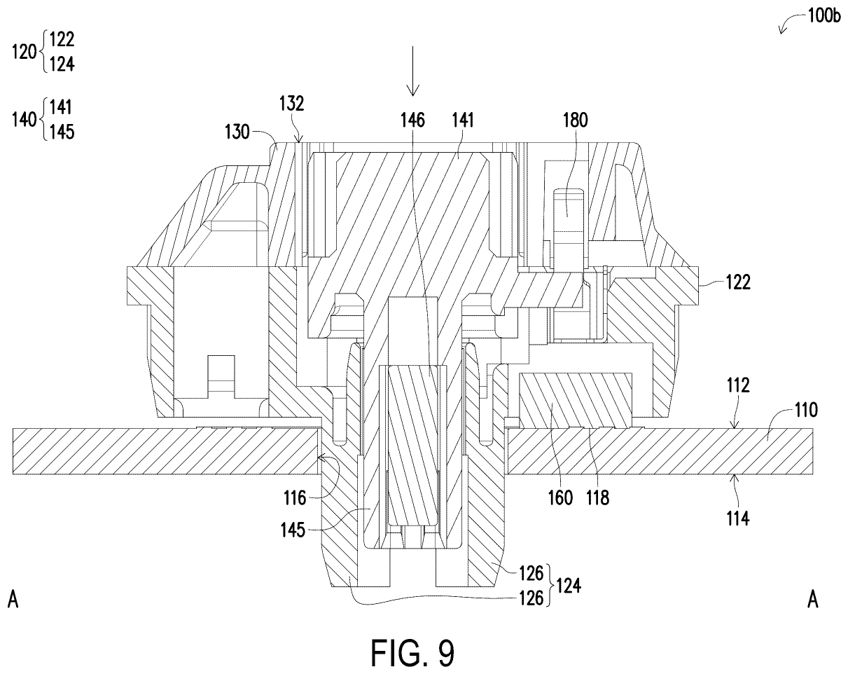

FIG. 8 is a cross-sectional view of a pressing device according to another embodiment of the disclosure. FIG. 9 is a schematic view of the movable shaft body in FIG. 8 being pressed down. Referring to FIG. 8 to FIG. 9, the difference between a pressing device 100b of this embodiment and the pressing device 100 in FIG. 1 is that in this embodiment, the pressing device 100b further includes a magnetic sensor 160 disposed on the circuit board 110 and positioned near the hollow shaft base 124. In this embodiment, the magnetic sensor 160 is disposed on the first surface 112 of the circuit board 110, but the disposition position of the magnetic sensor 160 is not limited thereto.

In addition, in this embodiment, the induction member 146 is a magnet. When the movable shaft body 140 is pressed down, the magnet passes through the through hole 116 of the circuit board 110, and moves close to or away from the magnetic sensor 160. Therefore, the pressing device 100b senses, through the magnetic sensor 160, the magnetic field line change generated by the magnet moving close or away to determine whether it is triggered.

In a preferred embodiment, the induction member 146 (magnet) is a rectangular body, but the disclosure is not limited thereto. Compared with cylindrical magnets, the design using rectangular magnets allows the magnet to face the magnetic sensor 160 with the largest area to obtain the largest amount of magnetic field line, which benefits the magnetic sensor 160 in detecting the magnetic field line change caused by the magnet moving up and down.

Similarly, in this embodiment, the pressing device 100b may be triggered by the changes of induced current received by the induction coil 118, or/and may determine whether it is triggered by sensing, through the magnetic sensor 160, the magnetic field line change generated by the magnet moving close or away. The user may choose which trigger method to use through settings, or the pressing device 100b may also enable multiple trigger methods at the same time.

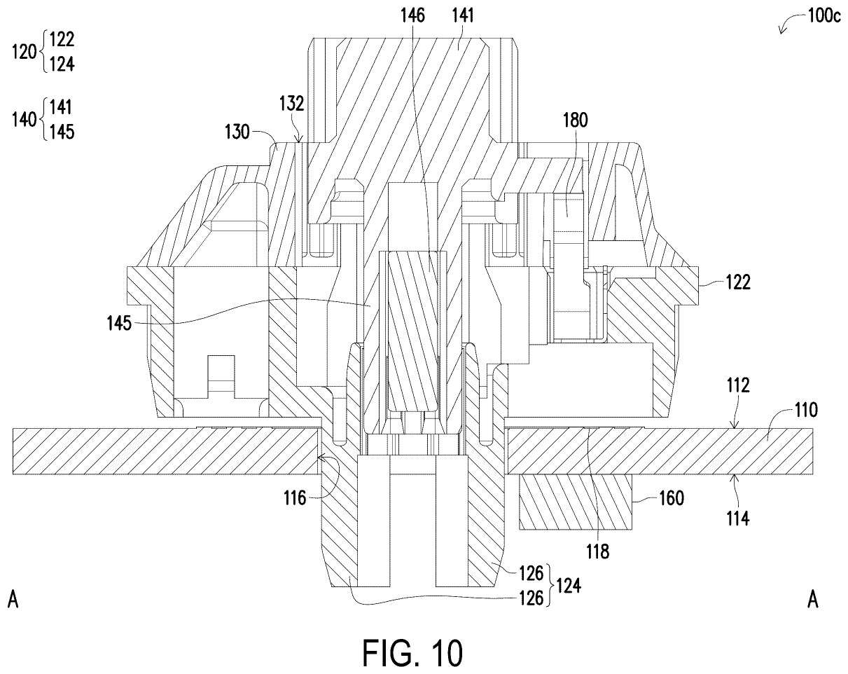

FIG. 10 is a cross-sectional view of a pressing device according to another embodiment of the disclosure. Referring to FIG. 10, the difference between a pressing device 100c of this embodiment and the pressing device 100b in FIG. 8 is that in this embodiment, the magnetic sensor 160 is disposed on the second surface 114 of the circuit board 110. Similarly, such a configuration may also enable the pressing device 100c to sense, through the magnetic sensor 160, the magnetic field line change generated by the magnet moving close or away to determine whether it is triggered.

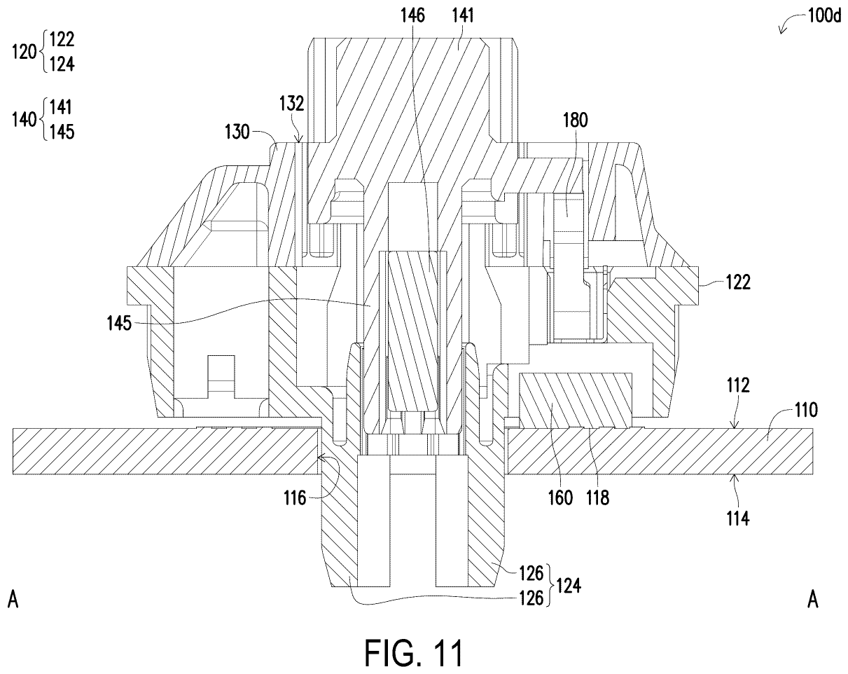

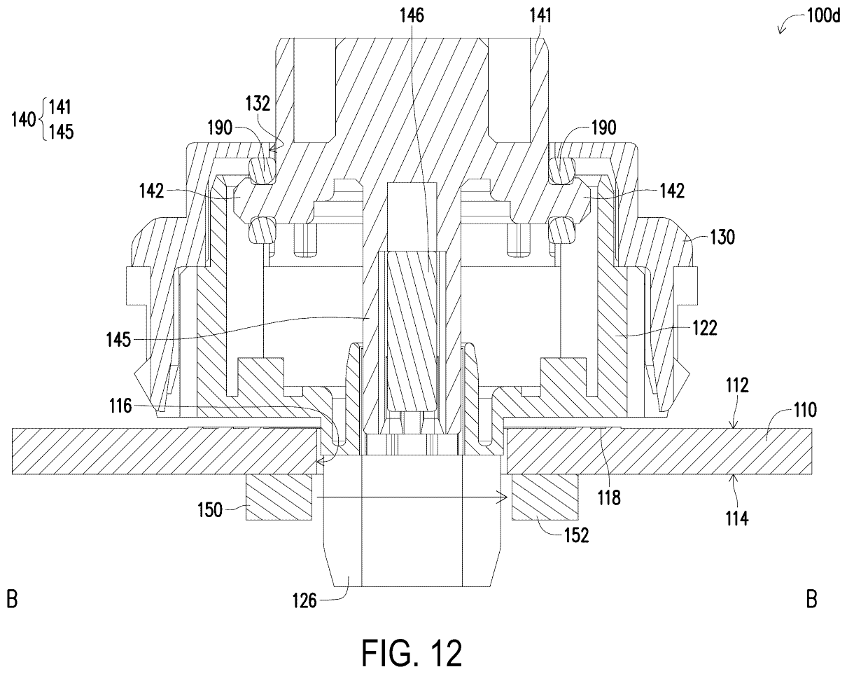

FIG. 11 is a cross-sectional view of a pressing device according to another embodiment of the disclosure. FIG. 12 is another cross-sectional view of the pressing device in FIG. 11. It should be noted that FIG. 11 and FIG. 12 are different cross-sections. FIG. 11 is similar to the A-A cross section in FIG. 1, and FIG. 12 is similar to the B-B cross section in FIG. 1.

Referring to FIG. 11 to FIG. 12, the difference between a pressing device 100d of this embodiment and the pressing device 100 in FIG. 1 is that in this embodiment, as shown in FIG. 11, the pressing device 100d further includes the magnetic sensor 160 disposed on the circuit board 110 and positioned near the hollow shaft base 124. The induction member 146 is a magnet. The structural configuration is similar to FIG. 8. When the movable shaft body 140 is pressed down, the magnet passes through the through hole 116 of the circuit board 110, and moves close to or away from the magnetic sensor 160. Therefore, the pressing device 100b senses, through the magnetic sensor 160, the magnetic field line change generated by the magnet moving close or away to determine whether it is triggered.

In addition, as shown in FIG. 12, the pressing device 100d further includes the light emitter 150 and the light receiver 152. The structural configuration is similar to FIG. 5. When the movable shaft body 140 is pressed down, the columnar shaft 145 and the induction member 146 are located in the light path, and the light emitted by the light emitter 150 is blocked by the columnar shaft 145 and the induction member 146. Therefore, the light receiver 152 does not receive the light emitted from the light emitter 150. Therefore, the pressing device 100d may determine whether it is triggered by whether the light receiver 152 receives light.

In other words, the pressing device 100d of this embodiment may be triggered by the changes of induced current received by the induction coil 118, or/and may determine whether it is triggered by sensing, through the magnetic sensor 160, the magnetic field line change generated by the magnet moving close or away, or/and may determine whether it is triggered by whether the light receiver 152 receives light. The user may choose which trigger method to use through settings, or the pressing device 100d may also enable multiple trigger methods at the same time.

In summary, in the disclosure, the circuit board of the pressing device includes the induction coil surrounding the through hole. The lower cover base of the shaft lower cover is disposed on the first surface of the circuit board, and the hollow shaft base penetrates the through hole and protrudes from the second surface of the circuit board. The shaft upper cover is disposed on the lower cover base. The movable shaft body is movably disposed between the shaft lower cover and the shaft lower cover, and includes a movable base and a columnar shaft protruding from the movable base. The movable base partially protrudes from the opening of the shaft upper cover, and the columnar shaft is embedded with the induction member. When the movable shaft body is pressed down, the columnar shaft extends into the hollow shaft base, and the induction member passes through the through hole, causing the induction coil to produce changes of induced current, thereby a triggering method different from the related art is provided. In addition, the through hole of the circuit board is designed for the hollow shaft base to penetrate, so that a part of the height of the hollow shaft base overlaps with the thickness of the circuit board, thereby reducing the overall height of the pressing device, and thus the pressing device can be applied to thin models.

What is claimed is:

1. A pressing device, comprising:
a circuit board comprising a first surface and a second surface opposite to each other, a through hole penetrating the first surface and the second surface, and an induction coil surrounding the through hole;
a shaft lower cover comprising a lower cover base and a hollow shaft base protruding from the lower cover base, wherein the lower cover base is disposed on the first surface;
a shaft upper cover disposed on the lower cover base and comprising an opening; and
a movable shaft body movably disposed between the shaft upper cover and the shaft lower cover, and comprising a movable base and a columnar shaft protruding from the movable base, wherein the movable base partially protrudes from the opening, and the columnar shaft is connected to an induction member, wherein
in response to the movable shaft body being pressed down, the columnar shaft extends into the hollow shaft base, and the induction member passes through the through hole, causing the induction coil to produce changes of induced current.

2. The pressing device as claimed in claim 1, further comprising a light emitter and a light receiver, wherein the hollow shaft base comprises two flap portions separated from each other, a light path is formed between the two flap portions, the light emitter and the light receiver are disposed on the second surface and are positioned on two sides of the two flap portions, wherein in response to the movable shaft body being not pressed down, light emitted by the light emitter is received by the light receiver via the light path.

3. The pressing device as claimed in claim 2, wherein in response to the movable shaft body being pressed down, the induction member is located in the light path, and the light emitted by the light emitter is blocked by the induction member.

4. The pressing device as claimed in claim 2, wherein the columnar shaft of the movable shaft body is opaque, wherein in response to the movable shaft body being pressed down, the columnar shaft is located in the light path, and the light emitted by the light emitter is blocked by the columnar shaft block.

5. The pressing device as claimed in claim 1, further comprising a magnetic sensor disposed on the circuit board and positioned near the hollow shaft base, wherein the induction member is a magnet, wherein in response to the movable shaft body being pressed down, the magnet passes through the through hole, and moves close to or away from the magnetic sensor.

6. The pressing device as claimed in claim 2, further comprising a magnetic sensor disposed on the circuit board and positioned near the hollow shaft base, wherein the induction member is a magnet, wherein in response to the movable shaft body being pressed down, the magnet passes through the through hole, and moves close to or away from the magnetic sensor.

7. The pressing device as claimed in claim 5, wherein the magnetic sensor is disposed on the first surface.

8. The pressing device as claimed in claim 5, wherein the magnetic sensor is disposed on the second surface.

9. The pressing device as claimed in claim 5, wherein the magnet is a rectangular body.

10. The pressing device as claimed in claim 1, further comprising an elastic element positioned between the shaft lower cover and the shaft upper cover, and fitted around the columnar shaft for the movable shaft body pressed to return to an original position.

11. The pressing device as claimed in claim 1, further comprising a metal spring plate disposed between the shaft lower cover and the shaft upper cover to provide tactile feedback during pressing.

12. The pressing device as claimed in claim 1, further comprising a buffer member, wherein the movable shaft body comprises a positioning portion protruding from a side of the movable base, the buffer member is fitted around the positioning portion of the movable shaft body, and the positioning portion is positioned between the shaft lower cover and the shaft upper cover.

13. The pressing device as claimed in claim 12, wherein in response to the movable shaft body being not pressed down, the buffer member abuts the shaft upper cover, and in response to the movable shaft body being pressed down, the buffer member abuts the shaft lower cover.

14. The pressing device as claimed in claim 1, wherein the opening is a rectangle, and an outer contour of the movable base corresponds to an inner contour of the opening.

15. The pressing device as claimed in claim 1, wherein the shaft lower cover comprises a first engaging portion, and the shaft upper cover includes a second engaging portion corresponding to the first engaging portion.
